(19) United States
(12) Patent Application Publication
(10) Pub. No.: US 2006/0047605 A1
(43) Pub. Date: Mar. 2, 2006

(54) Privacy management method and apparatus

(76) Inventor: Omar Ahmad, San Carlos, CA (US)

Correspondence Address: Wiesner & Associates, 366 Cambridge Avenue, Palo Alto, CA, 94306, US

(21) Appl. No.: 11/207,475

(22) Filed: Aug. 18, 2005

Related U.S. Application Data
(60) Provisional application No. 60/605,015, filed on Aug. 27, 2004.

(51) Int. Cl. G06Q 99/00

(52) U.S. Cl. 705/64

(57) ABSTRACT

A computer implemented method describes managing privacy information. Initially, a request is received from a requester for the privacy information of an entity. The request is often the result of an applicant submitting a form or application to the requester. Next, implementations of the present invention create a privacy transaction in a database for the privacy information including one or more identity qualities from the applicant and one or more characteristics for the submission. These identity qualities, characteristics for the submission and other pieces of information are used to score the privacy transaction according to the one or more identity qualities from the applicant and the one or more characteristics for the submission. The score provides a confidence level indicative of the authenticity and authorization associated with the submission.

This application is related to and claims priority to U.S. Provisional Application Ser. No. 60/605,015 by Omar Ahmad filed Aug. 27, 2004, entitled “Identity Verification Method and Apparatus” and incorporated by reference in the entirety herein.

### INTRODUCTION

The present invention relates generally to privacy. Rapid increases in the availability of information over the Internet and other networks have made access to privacy information of greater concern. Often, privacy information entered on forms or in applications is transmitted over large distances through the Internet to various businesses for processing. If this privacy information is intercepted by an interloper, it is possible that it can be used in conjunction with making unauthorized purchases or other commercial uses. Privacy information can also be used with a variety of unauthorized non-commercial uses as well. For example, information obtained through identity theft can be used for illegal work visas, passports and other types of permits. Illegal use or unauthorized use of privacy information is quite broad as the privacy information ranges from social security information, credit lines and medical conditions to bank accounts and civil disputes.

Credit bureaus and other businesses collect privacy information legally and resell it to various parties requesting the information. Generally, banks and other businesses require a portion of the privacy information from a person, corporation or other entity in conjunction with a line of credit, a secured or unsecured loan or other type of financing. Governmental agencies may also require privacy information associated with these various entities to provide certain permits or governmental clearances. In some cases, employers may even base employment decisions upon a person's credit rating or other details associated with privacy information. To ensure the information can be relied upon, the credit bureaus and other third parties work to ensure the information is reliable, objective and unbiased as possible. Generally, these various entities support the exchange of privacy information between credit bureaus and requesting organizations as long as it facilitates and promotes the entities' business and personal needs.

Unfortunately, the prevalence of identity theft over the Internet and through other means has made it too easy to access privacy information stored in various places on the Internet and on databases managed by the credit bureaus and other businesses. Basic privacy information obtained over the Internet and other sources can then be used to request and obtain more detailed privacy information on an individual or business. For example, it may be possible to receive a credit report from a credit bureau having a social security number or EIN and a forged signature. This information in turn can be used to open lines of credit, obtain unsecured debt, open bank accounts and perform other illicit financial transactions.

Victims of identity theft can suffer serious financial and personal consequences. Either the identity theft victim or the company extending credit must eventually pay for the monetary loss associated with falsified accounts, credit lines and purchases. This can often take months if not years for the person or company to clear up and resolve. Meanwhile, if a person or company's credit is ruined they may not be able to obtain subsequent credit lines as easily or may be subject to highly inflated interest rates to compensate for the perceived risk.

Federal and state legislation passed concerning the handling of credit information and privacy information helps but does not solve these and other problems. The Fair Credit and Reporting Act (FCRA), 15 U.S.C. Sec. 1681 et seq. drafted in 1970 and subsequently amended is the primary Federal statute enacted concerning credit and related privacy information. Most recently, the Fair and Accurate Credit Transactions (FACT) Act of 2003 was enacted as an amendment to the FCRA and designed to assist in reducing identity theft and related problems. Both the FCRA and the FACT Act amendment however do not provide guidelines for implementing these in a commercial or business environment.

Credit bureaus and other institutions need to comply with these Federal statutes and related state statutes while disseminating credit and other privacy information. The lack of any standard for compliance has made it difficult to implement the FCRA and FACT Acts while simultaneously promoting the use of privacy information in business and other settings. Similarly, people and corporations concerned with avoiding identity thefts and abuses need an efficient mechanism for ensuring these statutes are used to protect them from identity theft without impacting their ability to obtain credit lines and perform other transactions requiring the release of the privacy information.

### BRIEF DESCRIPTION OF THE DRAWINGS

The present invention is illustrated by way of example and not limitation in the figures of the accompanying drawings in which:

FIG. 1 depicts the management of privacy information in accordance with one implementation of the present invention;

FIG. 2 is a flowchart diagram of the operations used by an applicant to delegate the management of privacy information for an entity;

FIG. 3A and FIG. 3B depict flowcharts for managing the release, access, and use of privacy information in accordance with various implementations of the present invention;

FIG. 4 is a flowchart diagram of the operations for scoring a privacy transaction in accordance with one implementation of the present invention; and

FIG. 5 illustrates a system for implementing privacy management according to one implementation of the present invention.

Like reference numbers and designations in the various drawings indicate like elements.

### SUMMARY

One aspect of the present invention features a method for managing privacy information. Initially, a request is received from a requestor for the privacy information of an entity. The request is often the result of an applicant submitting a form or application to the requester. Next, implementations of the present invention create a privacy transaction in a database for the privacy information including one or more identity qualities from the applicant and one or more characteristics for the submission. These identity qualities, characteristics for the submission and other pieces of information are used to score the privacy transaction according to the one or more identity qualities from the applicant and the one or more characteristics for the submission. The score provides a confidence level indicative of the authenticity and authorization associated with the submission.

Another aspect of the present invention features a method of delegating the management of privacy information. Often the delegation occurs as a request from an applicant for a privacy management provider to manage privacy information of an entity. Before allowing this request, the applicant's identity is verified as authentic against an identification database. Further verifying occurs against an authorization database to see if the applicant is authorized to delegate management of the privacy information for the entity. If the delegation is appropriate, the delegation generates an indication in a database holding the privacy information that managing the privacy information has been delegated to a privacy management provider.

### DETAILED DESCRIPTION

Aspects of the present invention concern a method and system for managing privacy information. An operation is provided to mark privacy information for an entity and indicate a sequence of operations to be taken before the privacy information is released. The applicant requesting the mark on the privacy information is subjected to identity verification as well as a determination of authority to act. In some cases, the applicant and entity are one and the same individual or person and in other cases the applicant may be acting on behalf of the entity. For example, the entity may be a corporation, trust or other legal entity and the applicant may be an officer, trustee or other legal representative of the corporation, trust or other legal entity.

Once the privacy information is marked, a sequence of operations need be performed before the privacy information can be released. Aspects of the present invention not only ensure the sequence of operations are performed but also rates the overall confidence of the operations with a score leading up to and concurrent with the release of this privacy information. The score gives a rating as to the reliability of the applicant requesting the privacy information of the entity.

Aspects of the present invention are advantageous in at least one or more of the following ways. Entities can restrict release of privacy information and thereby reduce identity theft and related problems. In part, the privacy information is more difficult to obtain as each entity may use a different sequence of operations to condition release. This variation makes it more difficult for unauthorized parties to use privacy information of another entity.

A privacy management provider ensures that privacy information is released to authorized parties in a timely and efficient manner. For example, a privacy management provider may be a business that works with one or more credit reporting bureaus to ensure privacy is released in accordance with certain statutory and other standards (i.e., the FACT Act of 2003 is one such statutory standard concerning privacy information). TrustedID, Inc. of 555 Twin Dolphin Drive, Redwood City, Calif. 94063, is one such privacy management provider.

Each request for privacy information corresponds to a privacy transaction and is eventually assigned a score. Using this score, the privacy management provider can quickly recommend to restrict or release privacy information when requested thus not inhibiting transactions clearly authorized and desired by an entity. The scoring associated with each privacy transactions also enables the requesting party for the credit and privacy information to compare different requests for privacy information and eventually gauge the reliability of the identity of the applicant or entity.

Further, by creating a standardized implementation and approach, credit bureaus and other businesses exchanging credit data and privacy information can readily comply with Federal and State statutes. The privacy management provider operates as a separate function charged with deciding how to handle release of privacy information. For example, these functions can be kept separate from the credit bureaus and other businesses acting as a repository or overlaid and integrated into credit bureaus and other businesses existing infrastructure.

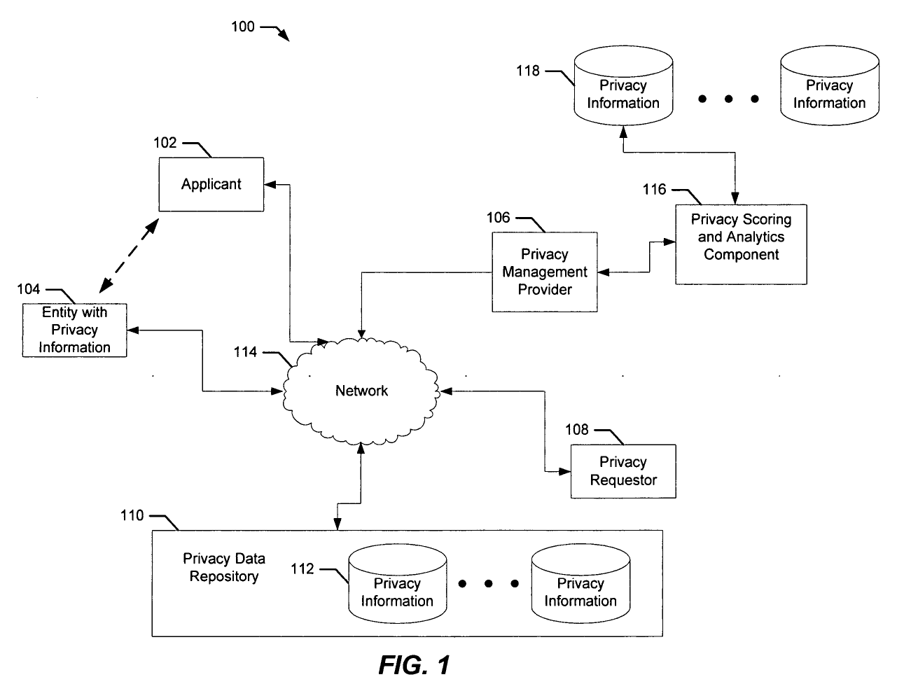

Privacy system 100 (hereinafter system 100) in FIG. 1 depicts the management of privacy information in accordance with one implementation of the present invention. System 100 as depicted may include an applicant 102, an entity with privacy information 104 (hereinafter entity 104), a privacy management provider 106, a privacy requester 108 (hereinafter requestor 108), privacy data repository 110 and privacy information database 112 all communicating over network 114. Additionally, privacy management provider 106 may include a privacy scoring and analytics component 116 (hereinafter scoring component 116) and additional privacy information database 118.

In operation, an applicant 102 generally submits an application or form requiring the release of some type of privacy information to requestor 108. For example, applicant 102 may be requesting a credit card or line of credit from requester 108 in conjunction with a retail purchase of goods or any other business transaction. While applicant 102 and entity 104 appear separately in FIG. 1, they often are the same person or individual. In the case entity 104 is a corporation or other legal entity, however, applicant 102 may represent being an agent or representative of entity 104. For purposes of explanation, the privacy information being sought by applicant 102 is associated with entity 104 and held in privacy information database 110, privacy information database 116 or a combination thereof. Privacy information can include credit and payment history, identity information, financial information, medical information, family information and any other information considered private or proprietary.

In response to the submission by applicant 102, requester 108 generates a request for privacy information from privacy management provider 106. Requestor 108 generally needs the requested privacy information to continue forward and do business with applicant 102. For example, requester 108 can be a credit card company, a bank or other financial institution attempting to determine whether to extend credit or financing terms to applicant 102 based upon privacy information associated with entity 104. It may also be a hospital interested in accessing medical records for applicant 102 before being admitted to the hospital for care and treatment. As previously described, it is possible that applicant 102 is a representative or agent to entity 104. It is also possible that applicant 102 is fraudulently acting as entity 104 under the guise of a stolen identity.

Privacy management provider 106 creates a privacy transaction to track the processing of information associated with the request from requestor 108 for privacy information. This privacy transaction includes information concerning the identity of applicant 102 and the details of the submission made by applicant 102 to requestor 108. Privacy management provider 106 provides these and other details to scoring component 116 to determine a score for the privacy transaction taking place. Privacy information databases 118 and or 112 can be used in scoring component 116 for the scoring of the privacy transaction. Often, a higher score for the privacy transaction indicates that applicant 102 is less likely to be using a stolen identity and/or has authority to act while a lower score for the privacy transaction may signify a question with the true identity of applicant 102 or otherwise flag some questionable activity regarding the privacy transaction taking place.

The score is then provided to privacy requester 108 along with the privacy information requested. In some cases, the privacy information may be omitted if the score associated with the privacy transaction is too low or does not meet some minimum threshold required for confidence in the transaction. Alternatively, the privacy information may be provided but the use of the privacy information in conjunction with a financial or other type of transaction may be significantly limited or restricted.

As an alternative implementation, privacy requester 108 may submit a request instead to privacy data repository 110. For example, this could be a credit bureau, a doctor's office or any other repository of privacy information for entity 104 or applicant 102. In this scenario, privacy data repository 110 would work with privacy management provider 106 to analyze the request using scoring component 116 to determine a score for the privacy transaction taking place. Privacy management provider 106 scores the privacy transaction to indicate if privacy requester 108 is authentic and/or has the authority to make the request and receive the information. Once again, privacy information databases 118 and or 112 can be used in scoring component 116 for the scoring of the privacy transaction. Often, a higher score for the privacy transaction indicates that applicant 102 is less likely to be using a stolen identity and/or has authority to act while a lower score for the privacy transaction may signify a question with the true identity of applicant 102 or otherwise flag some questionable activity regarding the privacy transaction taking place.

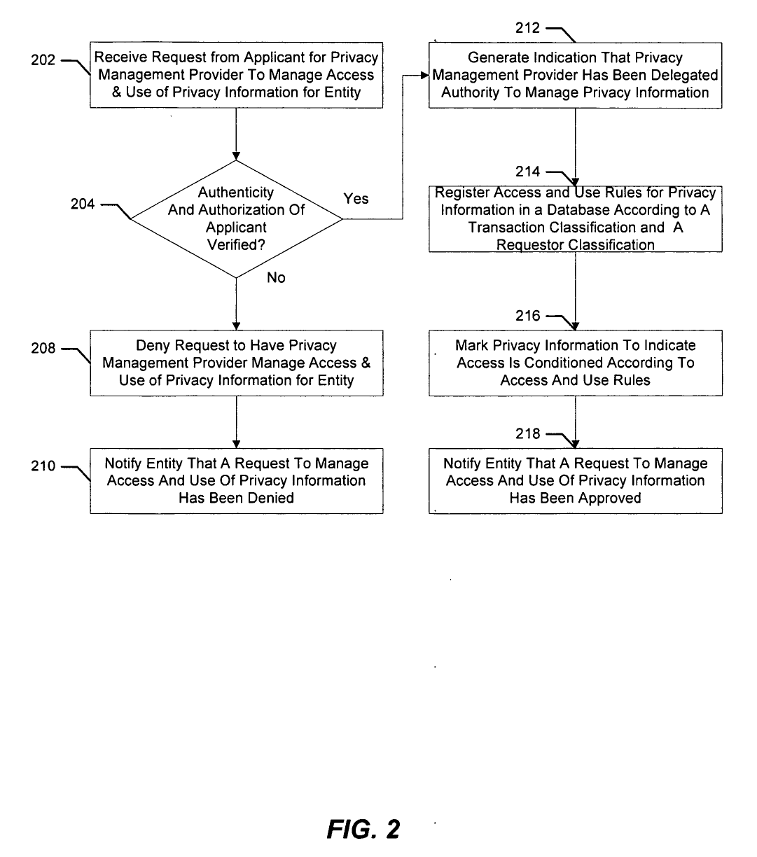

FIG. 2 is a flowchart diagram of the operations used by an applicant to delegate the management of privacy information for an entity. As previously mentioned, the privacy information describes an entity while the applicant is generally a person ostensibly with the authority to act on behalf of the entity. For example, the applicant and the entity may be the same party while in other cases the entity may be a legal entity such as a corporation and the applicant may be a person. Yet in other cases, the applicant may have obtained identity information of the entity illicitly and is fraudulently acting to obtain or use privacy information of the entity.

Accordingly, the initial operation in one implementation begins upon receipt of a request from the applicant for the privacy management provider to manage access and use of privacy information for the entity (202). To ensure the privacy information is managed properly, this request is generally made before the entity or the applicant acting on behalf of the entity engages in a transaction requiring privacy information for completion. In the event insufficient time has been allowed to process the request, privacy information will be released without the control and supervision of the privacy management provider.

As a preliminary matter, a determination is made as to the authenticity of the applicant's identity and the authority of the applicant to engage in delegating the entity's privacy information (204). In various implementations of the present invention, the applicant may be required to provide a variety of information in addition to a first name, last name and social security number in order to verify their identity as authentic. This information can include one or more of items including a business or driving license, secret questions and answers, a passport identifier and any other item considered peculiar to the applicant. In addition, one or more secure emails can be sent to the applicant to ensure the applicant has valid email address and is affiliated with the entity. For example, if the entity has a registered domain then it may be necessary for the applicant to have an email address also from the domain associated with the entity.

The aforementioned factors collected from the applicant are weighted according to their relative value in authentication, combined and then used to determine if the identity of the applicant is authentic. If the identity is determined not to be authentic or in question then the applicant's request for the privacy management provider to manage the privacy information is denied (208). This denial can be an express denial or, to avoid further potential requests, may be implied through the lack of a response confirming or denying problems or issues with the applicant's identity. Instead of further communication with the applicant, one implementation of the present invention may notify the entity that a request to manage access and use of the privacy information of the entity has been denied (210). It is presumed that the entity would follow-up with this notification to further determine what actions, if any, need be taken with respect to the applicant.

Alternatively, if the applicant is properly identified then a determination is also made to ensure the applicant also has the authority to act on behalf of the entity in delegating management of the privacy information. Generally, if the applicant and the entity are the same then it is presumed that the applicant also has the authority to delegate the management of the privacy information. However, if the applicant and entity are not the same then the applicant may be required to provide additional power of attorney paper work or sign an affidavit indicating they have the authority to act accordingly. To expedite processing, the applicant can sign the affidavit using digital signature technologies or other forms of electronic signatures that ensure the applicant has at least some legally responsibility for their actions.

Next, implementations of the present invention generates an indication that privacy management provider has been delegated authority to manage the privacy information (212). For example, this could be in the form of an email, mail or automated telephone call according to the contact information for the entity. Alternatively, the privacy information provider contact information and indication may also be included as a special trade-line in a credit report or other privacy information database for others to reference in the future.

Next, the applicant is provided the ability to register access and use rules for privacy information in a database according to a transaction classification and a requestor classification (214). This allows the applicant to devise a set of rules to control the release, access and use of privacy information by parties that may later request it. In accordance with implementations of the present invention classifications for the transaction and the requestor can be used to regulate the dissemination of privacy information. For example, the transaction classifications may conditionally release privacy information for transactions below a certain monetary amount yet disallow transactions exceeding another amount. Similarly, a requester from a credit card company may be allowed to receive privacy information while another requester from an auto dealership may be denied access. Moreover, the rules can also specify that certain specific requestors are given the privacy information more readily while other requesters are less likely to receive the privacy information.

Once the rules are registered, it becomes the responsibility of the privacy management provider to perform the operations and manage the privacy information. Accordingly, implementations of the present invention then enter a mark on the privacy information to indicate that the access to the privacy information is conditioned according to the access and use rules (216). By marking the privacy information in this manner any attempts to access the privacy information need first pass through the privacy management provider.

In the case of credit information and privacy information, the authority for marking the credit report can be found in the Fair Credit and Reporting Act (FCRA), 15 U.S.C. Sec. 1681 et seq. drafted in 1970 as subsequently amended as well as in amendments thereto enacted in the Fair and Accurate Credit Transactions (FACT) Act of 2003. Under the guise of the FCRA and the FACT Act the privacy management provider can request that a mark or flag is put into each of the one or more credit bureau databases to make sure the privacy information management responsibility is delegated appropriately. Otherwise, these acts do not expressly provide a method of implementing methods or apparatus for managing the privacy information as described above and below herein.

Once the request has been fulfilled, aspects of the present invention then notify the entity that a request to manage access and use of privacy information for the entity has been approved (218). Optionally, the applicant may also be notified that the privacy information is now being managed by the privacy management provider.

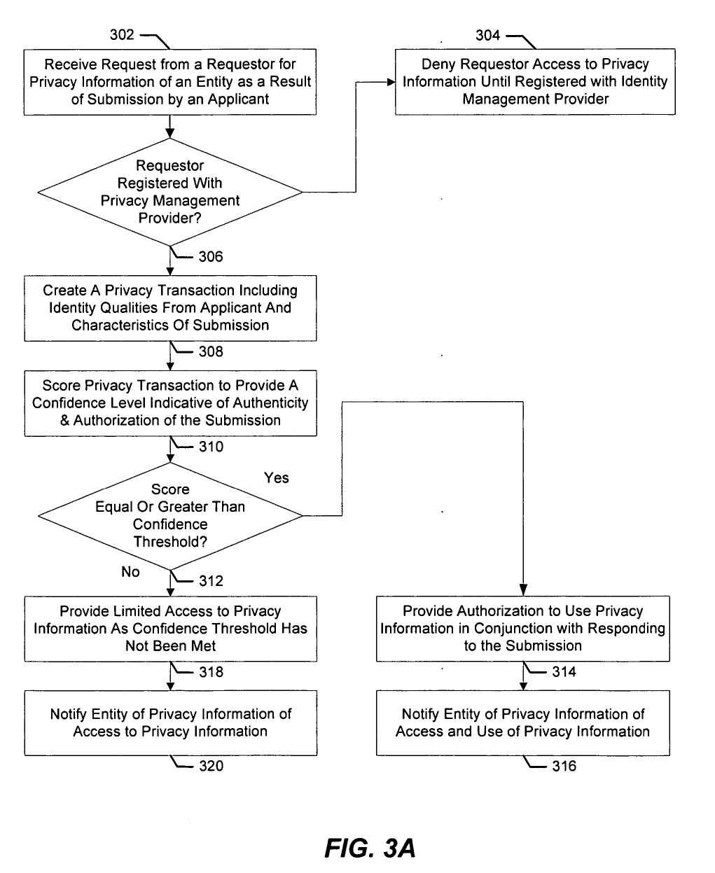

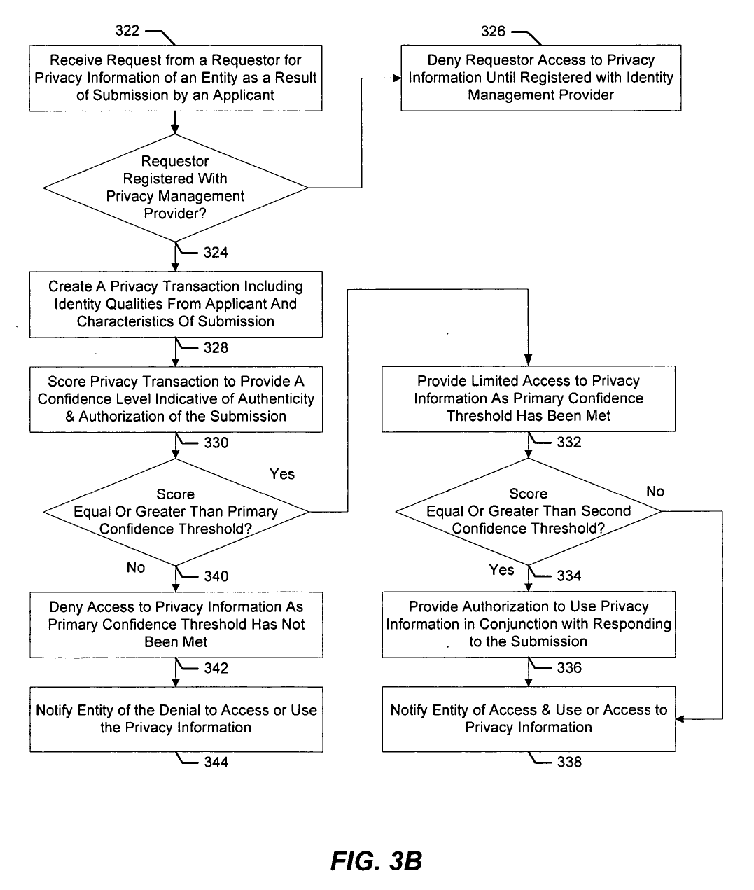

FIGS. 3A and 3B depict flowcharts for managing the release, access, and use of privacy information in accordance with various implementations of the present invention.

In FIG. 3A, implementations of the present invention may limit access to privacy information or grant unrestricted use depending on the requester and nature of the transaction. Managing the privacy information begins with a request from a requestor for privacy information of an entity as a result of a submission by an applicant (302). The applicant can be a person who submits an application or form to enter into some type of business or other transaction with the requester. As part of this interaction, the requestor may require some or all of the privacy information associated with the applicant or another entity to complete the request. As previously described, the application can be the same as the entity or may be acting on the entity's behalf. For example, the applicant may be a person requesting a line of credit or a credit card from a bank for the applicant or on behalf of a small-business or corporation.

In most cases, implementations of the present invention require the requester to be registered with the privacy management provider in advance before any privacy information can be released (306). If the requestor has already registered with the service in advance, the privacy management provider has ample opportunity to store the identity information for the requester and determine an optimal way of authenticating their identity efficiently and quickly on demand. Accordingly, the bank, credit union or other requestor may be required to first register with the privacy management provider to avoid being denied access to the privacy information (304).

Next, implementations of the present invention create a privacy transaction entry in a database that includes identity qualities from the applicant and various different characteristics from the particular submission made to the requester (308). This operation involves gathering detailed information from the applicant that can be cross-referenced with information provided in advanced and stored in the database upon the applicant's or entity's registration. For example, the applicant may be required to provide a variety of information in addition to a first name, last name and social security number in order to verify their identity as authentic. This information can include one or more of items including a business or driving license, secret questions and answers, a passport identifier and any other item considered peculiar to the applicant.

Likewise, information is also collected related to the particular submission made to the requester. Details on the type of request being made may be classified into one or more different categories as initially specified by the entity upon registration. These classifications may vary from entity to entity to enable the most appropriate control over the privacy information. For example, one entity may classify the submissions according to different ranges of dollar amounts (i.e., under $1000, $1000-$5000, $10,000 and up) while another entity may classify submissions according to the type of product being requested (i.e., car purchase, retail clothes, home improvement, revolving-debt, secured debt, school loans and others). The classifications are assigned different risks factors to be used later in scoring. Similarly, more details are obtained for each different classification and submission concerning the underlying purchase or request to use later during the scoring.

Implementations of the present invention then score the privacy transaction to provide a confidence level indicating of the authenticity and authorization of the submission to the requester (310). One of several different scoring formulas can be used to create an index for the transaction that draws correlations between the identity of the applicant, the accuracy of any additional information requested from the applicant during the scoring, the identity information provided by the application in the underlying submission and any other correlations that can be drawn from the various information stored in the databases. Also, the classification scheme used to categorize each of the submissions is also used to highlight submissions that require greater scrutiny or lesser scrutiny when releasing privacy information. For example, a small mortgage broker requesting privacy information may be classified as requiring greater scrutiny than a large publicly traded bank requesting privacy information. Consequently, a score for the former submission may be lower than the score from the latter submission to reflect the differential in risk.

The score determines how the privacy information is managed on behalf of the entity. In this example, if the score is equal or greater than a confidence threshold (312) then implementations of the present invention provide authorization to use the privacy information in conjunction with responding to the submission made to the requestor (314). For example, a privacy transaction from a bank making a loan on a house would be given the ability to both access a person's credit information as well as use the credit information in determining whether to extend the person a secured loan for his or her home. To keep the entity apprised of such events, implementations of the present invention provides a notification that the privacy information has been accessed and used (316). This may involve sending an email or letter to the entity with details on the requester, the applicant and the nature of the privacy transaction that was allowed.

Alternatively, when the score is less than the confidence threshold (312) then implementations of the present invention instead provide limited access to the privacy information (318). A lower score indicates that something is not correct with respect to the identity of the application, the nature of the submission, the type of submission or transaction requested or various combinations thereof. Indeed, this option allows the requestor to receive the privacy information but not use it in making a determination of whether to respond to a particular submission. For example, the bank may be given access to view a credit report or other privacy information but because the confidence score is too low they cannot extend or deny a loan on this basis. This latter approach protects the entity from unauthorized parties from using their identity and/or privacy information to enter into business and other transactions. Once again, to keep the entity apprised of such events implementations of the present invention provides a notification that the privacy information has been accessed and but not used in response to a submission due to a lower score (320). This may involve sending an email or letter to the entity with details on the requester, the applicant and the nature of the privacy transaction that was allowed.

Referring now to FIG. 3B, an alternate set of operations depicts how implementations of the present invention may further refine access to privacy information depending on the requestor and nature of the transaction. Many of the operations in FIG. 3B are similar to those corresponding operations in FIG. 3A.

Once again, managing the privacy information begins with a request from a requestor for privacy information of an entity as a result of a submission by an applicant (322). The applicant can be a person who submits an application or form to enter into some type of business or other transaction with the requestor. As part of this interaction, the requestor may require some or all of the privacy information associated with the applicant or another entity to complete the request.

Implementations of the present invention may require the requestor to be registered with the privacy management provider in advance before any privacy information can be released (324). If the requestor has already registered with the service in advance, the privacy management provider has ample opportunity to store the identity information for the requester and determine an optimal way of authenticating their identity efficiently and quickly on demand. Accordingly, the bank, credit union or other requester may be required to first register with the privacy management provider to avoid being denied access to the privacy information (326).

Next, implementations of the present invention create a privacy transaction entry in a database that includes identity qualities from the applicant and various different characteristics from the particular submission made to the requester (328). This operation involves gathering detailed information from the applicant that can be cross-referenced with information provided in advanced and stored in the database upon the applicant's or entity's registration. For example, the applicant may be required to provide a variety of information in addition to a first name, last name and social security number in order to verify their identity as authentic. This information can include one or more of items including a business or driving license, secret questions and answers, a passport identifier and any other item considered peculiar to the applicant.

Likewise, information is also collected related to the particular submission made to the requestor. Details on the type of request being made may be classified into one or more different categories as initially specified by the entity upon registration. These classifications may vary from entity to entity to enable the most appropriate control over the privacy information. For example, one entity may classify the submissions according to different ranges of dollar amounts (i.e., under $1000, $1000-$5000, $10,000 and up) while another entity may classify submissions according to the type of product being requested (i.e., car purchase, retail clothes, home improvement, revolving-debt, secured debt, school loans and others). The classifications are assigned different risks factors to be used later in scoring. Similarly, more details are obtained for each different classification and submission concerning the underlying purchase or request to use later during the scoring.

Implementations of the present invention then score the privacy transaction to provide a confidence level indicating of the authenticity and authorization of the submission to the requester (340). One of several different scoring formulas can be used to create an index for the transaction that draws correlations between the identity of the applicant, the accuracy of any additional information requested from the applicant during the scoring, the identity information provided by the application in the underlying submission and any other correlations that can be drawn from the various information stored in the databases. Also, the classification scheme used to categorize each of the submissions is also used to highlight submissions that require greater scrutiny or lesser scrutiny when releasing privacy information.

The score determines how the privacy information is managed on behalf of the entity. In this example, if the score is equal or greater than a primary confidence threshold (340) then implementations of the present invention at least provide limited access to privacy information (332). For example, limited access to privacy information may allow a credit bureau to distribute a credit report to a requesting bank but will not allow the bank to grant a loan or credit-line based upon the information in the report.

To grant additional access or use, the score from the privacy transaction is compared against a secondary confidence threshold. A determination that the score is equal or greater than this secondary confidence threshold provides authorization to use the privacy information in conjunction with responding to the submission made to the requestor (336). For example, a bank making a loan on a house would be given the ability to both access a person's credit information as well as use the credit information in determining whether to extend the person a secured loan for his or her home. To keep the entity apprised of such events, implementations of the present invention provides a notification that the privacy information has been accessed and used (338).

If the score is less than the secondary confidence threshold but greater than the primary confidence threshold then this additional authorization to use the privacy information is denied and the requestor has only limited access rights to the privacy information (334). Once again, implementations of the present invention notifies the entity that the privacy information has been accessed but not used by a requester (338). In the event the score is also less than the primary confidence threshold then the requestor is essentially denied any access or use of the privacy information.

Alternatively, when the score is less than the primary confidence threshold (340) then implementations of the present invention instead denies all access or use of the privacy information (342). In this case, a lower score indicates that something is not correct with respect to the identity of the application, the nature of the submission, the type of submission or transaction requested or various combinations thereof. By denying all access or use of the privacy information, this approach provides an entity with the greatest protection from unauthorized parties using their identity and/or privacy information to enter into business and other transactions. Implementations of the present invention notify the entity that the privacy information was requested but that no access to the privacy information or use thereof had been granted due to a low privacy transaction score (344).

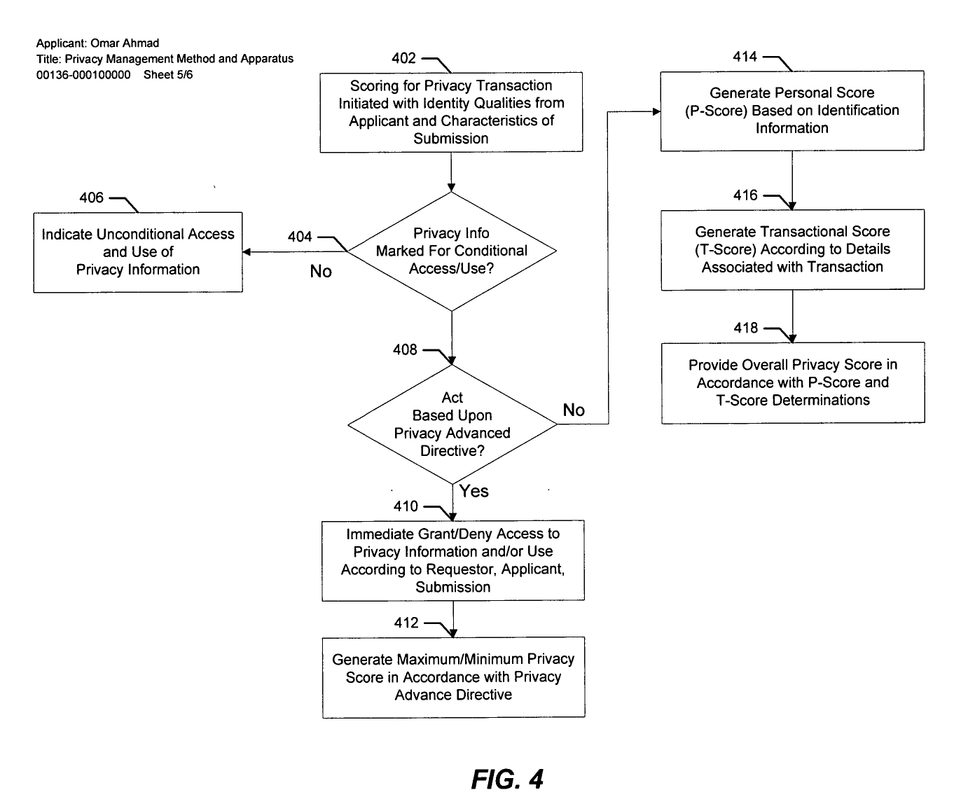

FIG. 4 is a flowchart diagram of the operations for scoring a privacy transaction in accordance with one implementation of the present invention. The scoring is initiated with identity qualities from the applicant and characteristics of the submission made to the requestor (402). As previously described, identity information from applicant is used to authenticate the identity of the applicant in light of the particular submission being made. Characteristics of the submission are used to categorize the submission for privacy information and identify a level of scrutiny required for the particular submission.

A first determination is made to see if the privacy information for the particular entity has been marked for conditional access and/or use (404). If the privacy information has not been marked then an indication is provided that unconditional access and use of the privacy information is available (406). This typically means that the entity associated with the privacy information has not requested limited access through a privacy management provider, credit bureau or other holder of privacy information. In terms of scoring, a privacy transaction would receive a maximum scoring to enable both access and use of the privacy information.

In the event the privacy information is marked, a determination is made to see if a privacy advanced directive should be used to score the privacy transaction (408). The privacy advanced directive provides an entity the ability to specify if class as determined by the particular requester, applicant, submission or combination thereof should be granted or denied access or use (410). Depending on whether access and/or use is granted, implementations of the present invention generate a maximum or minimum privacy transaction score in accordance with details of the privacy advanced directive (412). For example, an applicant can decide to deny all credit card agencies access and use of privacy information using a privacy advanced directive despite any privacy transaction scoring.

Alternatively, if there is no privacy advanced directive then implementations of the present invention perform a scoring of the privacy transaction. A first portion of the scoring involves creating a personal score (p-score) according to identification information provided by the applicant (414). For example, a higher p-score is provided when the person's identification information is consistent with information contained in various public and private databases for the individual. Also, the p-score may be higher when personal information provided by the applicant corresponds to personal information from the entity. Matching social security numbers between the applicant and the entity would increase a p-score while dissimilar social security numbers would decrease a p-score.

In addition, implementations of the present invention generate a transaction score (t-score) to rate the particular submission (416). The submission for a small credit line less than $500 may result in a higher t-score compared with a larger credit line submission for $50,000 all other factors being equal. Similarly, high correlation between the submission information and personal information of the applicant and the entity can also result in a higher t-score. Together, the p-score and t-score are combined in weighted manner to provide an overall privacy transaction score to be used as previously described (418).

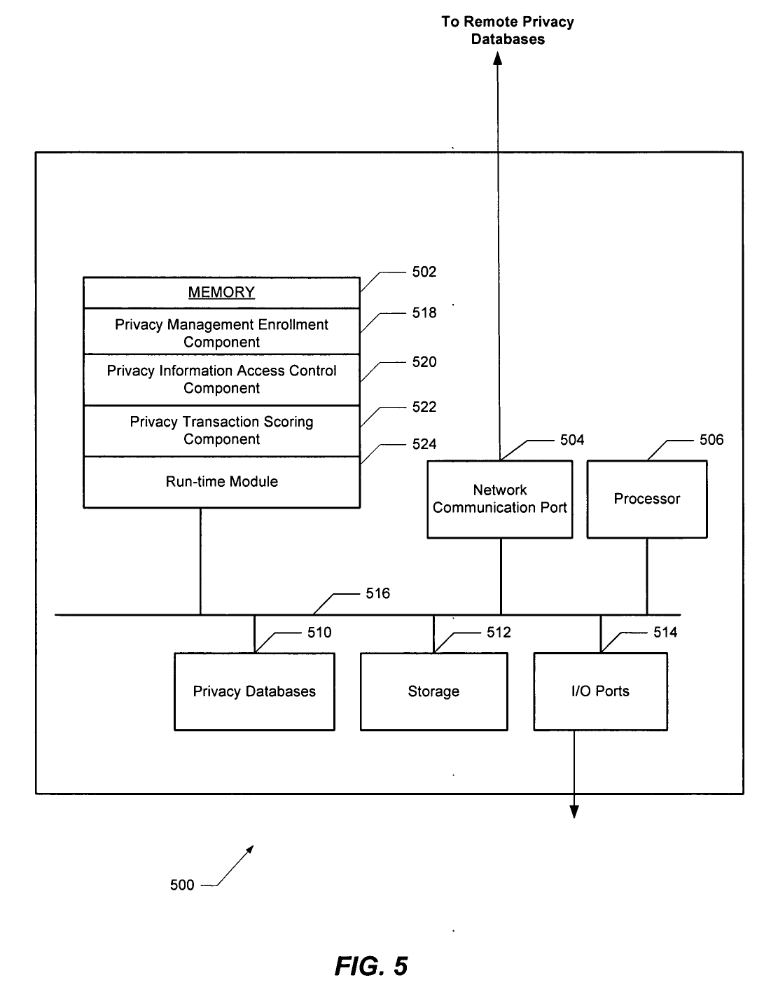

FIG. 5 illustrates a system for implementing privacy management according to one implementation of the present invention. System 500 includes a memory 502 to hold executing programs (typically random access memory (RAM) or read-only memory (ROM) such as a flash ROM), a network communication port 504 for data communication, a processor 506, privacy databases 510, secondary storage 512 and I/O ports 514 for connecting to peripheral devices all operatively coupled together over an interconnect 516. System 500 can be preprogrammed, in ROM, for example, using field-programmable gate array (FPGA) technology or it can be programmed (and reprogrammed) by loading a program from another source (for example, from a floppy disk, a CD-ROM, or another computer). Also, system 500 can be implemented using customized application specific integrated circuits (ASICs).

In various implementations of the present invention, memory 502 holds a privacy management enrollment component 518, a privacy information access control component 520 and a privacy transaction scoring component 522 and a run-time 524 for managing one or more of the above and other resources.

Privacy management enrollment component 518 is an interface for applicants to delegate the management of privacy information to a privacy management provider. As previously described, the privacy management provider verifies the authenticity and authority of the applicant to engage in delegating this function over to the privacy management provider on behalf of a particular entity. In some cases, the applicant is the same as the entity and therefore is delegating management of the applicant's privacy information to the privacy management provider.

Privacy information access control component 520 determines how the privacy information for an entity should be disseminated. The privacy management provider uses these operations to generate a privacy transaction and then associate the privacy transaction with a score. The score provides a level of confidence as to the identity of the applicant and the risks associated with the particular submission. Depending on the scoring, the privacy information access control component 520 may grant access and use of privacy information, access only to the privacy information or deny all access and use of the privacy information. Privacy transaction scoring component 522 includes the routines and operations used to score a particular privacy transaction.

Implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

While specific embodiments have been described herein for the purposes of illustration, various modifications may be made without departing from the spirit and scope of the invention. Thus, the invention is not limited to the specific embodiments described and illustrated above. For example, a primary and secondary confidence threshold were used to provide access and use of privacy information however a greater or fewer number of confidence thresholds were contemplated for use in controlling the dissemination of privacy information. Further, a score is described as being based upon a personal score (p-score) and a transaction score (t-score) however it is also contemplated that a greater number of factors or fewer number of factors could be used to generate a score useful in rating a privacy transaction.

Accordingly, the invention is not limited to the above-described implementations, but instead is defined by the appended claims in light of their full scope of equivalents.

What is claimed is:

1. A computer implemented method for managing privacy information, comprising:
receiving a request from a requestor for the privacy information of an entity as a result of a submission by an applicant;
creating a privacy transaction in a database for the privacy information including one or more identity qualities from the applicant and one or more characteristics for the submission; and
scoring the privacy transaction according to the one or more identity qualities from the applicant and the one or more characteristics for the submission to provide a confidence level indicative of the authenticity and authorization of the submission.

2. The method of claim 1 further comprising:
comparing the confidence level with a confidence threshold as a guide for managing the privacy information; and
providing the requester access to the privacy information of the entity when the comparison indicates that confidence level is less than the confidence threshold.

3. The method of claim 2 further comprising:
providing the requestor the ability to use the privacy information of the entity in conjunction with responding to the submission by the applicant when the comparison indicates that confidence level is at least equal or greater than the confidence threshold.

4. The method of claim 1 wherein the requestor is selected from set of requesters including: a credit reporting agency, a credit processing agency, a banking institution, a medical institution, a retail sales company and a prospective employer.

5. The method of claim 1 wherein the submission is selected from a set of submissions including: a credit card application, a rental application, a job application, a loan application and a medical admission application.

6. The method of claim 1 wherein the privacy information includes one or more types of information selected from a set including: a social security number, a mortgage payment history, a credit card payment history, a list of landlord-tenant disputes and evictions, a payment delinquency, a charge-off, a physical medical condition, a mental medical condition and a criminal record.

7. The method of claim 1 wherein the entity is selected from a set including: a real person, a corporation, a partnership and other legal entities.

8. The method of claim 1 wherein the applicant is seeking something from the requester by way of the submission.

9. The method of claim 1 wherein the applicant is a representative of the entity associated with the privacy information.

10. The method of claim 1 wherein the applicant is the same as the entity associated with the privacy information.

11. The method of claim 1 wherein the one or more identity qualities from the applicant includes one or more qualities selected from a set including: a social security number, a first name, a last name, a home address, a business address, a previous home address, a previous business address, employment related information and names associated with related family members.

12. The method of claim 1 wherein the one or more characteristics for the submission includes information that can be cross-referenced with privacy information of the entity.

13. A computer implemented method of managing privacy information comprising:
receiving a request from an applicant for a privacy management provider to manage privacy information of an entity;
verifying an identity of the applicant's identity as authentic against an identification database and further verifying authorization against an authorization database to ensure applicant's authority to delegate management of the privacy information for the entity; and
generating an indication in a database holding the privacy information that managing the privacy information has been delegated to a privacy management provider.

14. The method of claim 13 further comprising:
registering one or more rules in a database for the privacy management provider to provide the access and use of privacy information; and
marking the privacy information to indicate access and use is condition according to access and use rules in the database.

15. The method of claim 14 wherein registering the one or more rules further comprises:
creating rules that depend upon classifications associated with a type of transaction and a type of requester.

16. A computer program product for managing privacy information, tangibly stored on a computer-readable medium, comprising instructions operable to cause a programmable processor to:
receive a request from a requestor for the privacy information of an entity as a result of a submission by an applicant;
create a privacy transaction in a database for the privacy information including one or more identity qualities from the applicant and one or more characteristics for the submission; and
score the privacy transaction according to the one or more identity qualities from the applicant and the one or more characteristics for the submission to provide a confidence level indicative of the authenticity and authorization of the submission.

17. The computer program product of claim 16 further comprising instructions to:
compare the confidence level with a confidence threshold as a guide for managing the privacy information; and
provide the requestor access to the privacy information of the entity when the comparison indicates that confidence level is less than the confidence threshold.

18. The computer program product of claim 17 further comprising instructions to:
provide the requestor the ability to use the privacy information of the entity in conjunction with responding to the submission by the applicant when the comparison indicates that confidence level is at least equal or greater than the confidence threshold.

19. The computer program product of claim 16 wherein the one or more characteristics for the submission includes information that can be cross-referenced with privacy information of the entity.

20. A computer program product for managing privacy information, tangibly stored on a computer-readable medium, comprising instructions operable to cause a programmable processor to:
receive a request from an applicant for a privacy management provider to manage privacy information of an entity;
verify an identity of the applicant's identity as authentic against an identification database and further verifying authorization against an authorization database to ensure applicant's authority to delegate management of the privacy information for the entity; and
generate an indication in a database holding the privacy information that managing the privacy information has been delegated to a privacy management provider.

21. The computer program product of claim 20 further comprising instructions to:
register one or more rules in a database for the privacy management provider to provide the access and use of privacy information; and
mark the privacy information to indicate access and use is condition according to access and use rules in the database.
The computer program product of claim 21 wherein instructions that register one or more rules further comprise instructions to:
create rules that depend upon classifications associated with a type of transaction and a type of requester.
